(19) United States
(12) Patent Application Publication
(10) Pub. No.: US 2026/0274232 A1
(43) Pub. Date: Sep. 17, 2026

(54) ELECTRIC CYLINDER DEVICE AND BRAKE FLUID PRESSURE CONTROL DEVICE

(71) Applicant: ADVICS CO., LTD., Kariya-shi, Aichi-ken (JP)

(72) Inventor: Shingo ONODA, Kariya-shi, Aichi-ken (JP)

(73) Assignee: ADVICS CO., LTD., Kariya-shi, Aichi-ken (JP)

(21) Appl. No.: 19/168,024

(22) PCT Filed: Mar. 29, 2024
(86) PCT No.: PCT/JP2024/013231

§ 371 Date: Sep. 23, 2025

(30) Foreign Application Priority Data
Mar. 30, 2023 (JP) 2023-054971

(51) Int. Cl. B60T 13/74; B60T 13/14; F15B 15/14; F15B 15/20

(52) U.S. Cl. CPC B60T 13/745; B60T 13/148; F15B 15/1447; F15B 15/20

(57) ABSTRACT

As an example, an electric cylinder device according to an embodiment includes a housing provided with a cylinder, a piston disposed inside the cylinder, a rotating member that rotates about a rotational axis, a linear motion member attached to the rotating member so as to move in a first direction along the rotational axis or a second direction opposite to the first direction according to rotation of the rotating member, the linear motion member pushing the piston so as to reduce a volume of a liquid chamber of the cylinder by moving in the first direction, and a first engaging portion provided at the piston, a second engaging portion that is provided at the linear motion member and contacts the first engaging portion to restrict a separation of the linear motion member from the piston in the second direction.

### TECHNICAL FIELD

Embodiments of the disclosure relate to an electric cylinder device and a brake fluid pressure control device.

### BACKGROUND ART

In the related art, there has been known an electric cylinder device including a rotation linear motion conversion mechanism that converts a rotational motion of an output shaft of a motor into a linear motion, and a piston advanced by the rotation linear motion conversion mechanism. The piston advanced by the rotation linear motion conversion mechanism reduces the volume of the liquid chamber and increases the pressure in the liquid chamber (Patent Literature 1).

### CITATION LIST

### Patent Literature

Patent Literature 1: JP 2012-214068 A

### SUMMARY

### Technical Problem

However, in the conventional configuration, the linear motion member that linearly moves in the rotation linear motion conversion mechanism and the piston are not coupled to each other. Therefore, there is a possibility that the linear motion member and the piston are away from each other.

Therefore, the disclosure has been made in view of the above, and provides an electric cylinder device and a brake fluid pressure control device capable of suppressing a separation of a piston and a linear motion member from each other.

### Solution to Problems

As an example, an electric cylinder device according to an embodiment includes a housing provided with a cylinder, a piston disposed inside the cylinder, a rotating member that rotates about a rotational axis, a linear motion member attached to the rotating member so as to move in a first direction along the rotational axis or a second direction opposite to the first direction according to rotation of the rotating member, the linear motion member pushing the piston so as to reduce a volume of a liquid chamber of the cylinder by moving in the first direction, and a first engaging portion provided at the piston, a second engaging portion that is provided at the linear motion member and contacts the first engaging portion to restrict a separation of the linear motion member from the piston in the second direction. Therefore, as an example, the first engaging portion and the second engaging portion can suppress the separation of the piston pulled by the negative pressure from the linear motion member, for example, when the pressure in the liquid chamber decreases.

### BRIEF DESCRIPTION OF DRAWINGS

FIG. 1 is a cross-sectional view schematically illustrating an electric cylinder device mounted on a brake System according to one embodiment.

FIG. 2 is a cross-sectional view illustrating a piston, a C ring, and a linear motion member of the embodiment.

FIG. 3 is a cross-sectional view partially illustrating the piston, the C ring, and the linear motion member of the embodiment.

FIG. 4 is a plan view illustrating the C ring of the embodiment.

FIG. 5 is a cross-sectional view illustrating the piston, the C ring, and the linear motion member before assembly of the embodiment.

### DESCRIPTION OF EMBODIMENTS

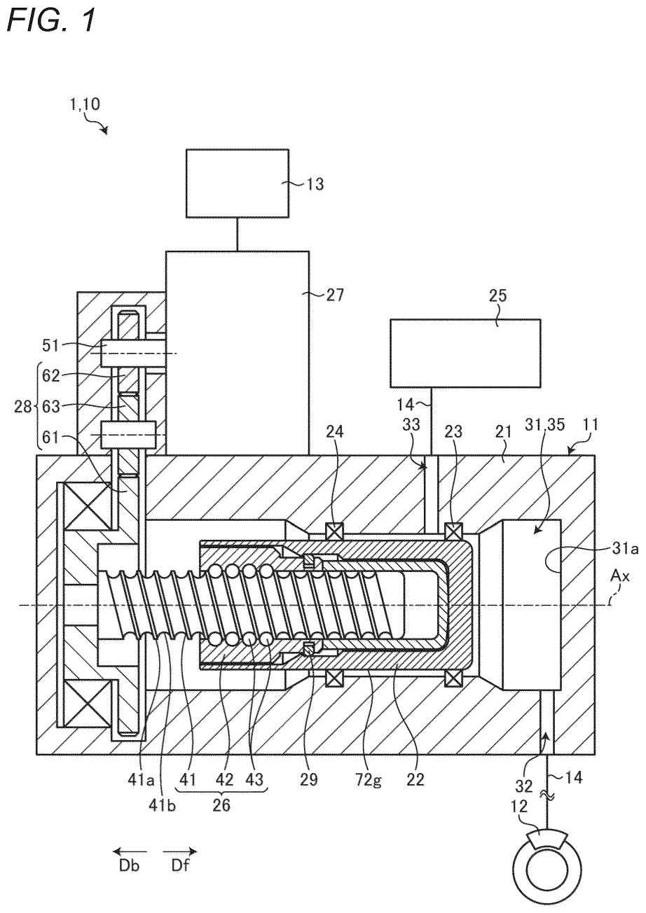

Hereinafter, one embodiment will be described with reference to FIGS. 1 to 5. Note that, in the present specification, components according to embodiments and descriptions of the components may be described in a plurality of expressions. The components and the description thereof are examples, and are not limited by the expression of the present specification. Components may be identified with names different from those herein. In addition, the component may be described by an expression different from the expression in the present specification.

FIG. 1 is a cross-sectional view schematically illustrating an electric cylinder device 11 mounted on a brake system 10 according to one embodiment. The brake system 10 is mounted on a vehicle 1 such as a four-wheeled automobile. The brake system 10 is not limited to this example. The brake system 10 is an example of a brake fluid pressure control device.

The brake system 10 includes the electric cylinder device 11, a wheel cylinder 12, an electronic control unit (ECU) 13, and a plurality of liquid paths 14. The brake system 10 may further include various other components such as a master cylinder, a pump, and an electromagnetic valve.

The electric cylinder device 11 is connected to the wheel cylinder 12 via the liquid path 14. The electric cylinder device 11 can increase the pressure in the brake fluid in the wheel cylinder 12 and generate the braking force of the vehicle 1.

The electric cylinder device 11 includes a housing 21, a piston 22, two seals 23 and 24, a reservoir 25, a rotation linear motion conversion mechanism 26, a motor 27, a speed reduction mechanism 28, and a C ring 29. The C ring 29 is an example of a second engaging portion.

The housing 21 is formed in a substantially cylindrical shape. A cylinder 31 is provided inside the housing 21. The cylinder 31 is a substantially columnar space extending along the central axis Ax. The central axis Ax is an example of a rotational axis. The central axis Ax is, for example, a virtual central axis of the cylinder 31. The central axis of the cylinder 31 may be different from the central axis Ax.

In the present specification, an axial direction, a radial direction, and a circumferential direction are defined for convenience. The axial direction is a direction along the central axis Ax. The axial direction includes a forward direction Df and a backward direction Db. The forward direction Df is an example of a first direction. The backward direction Db is a direction opposite to the forward direction Df and is an example of a second direction. The forward direction Df and the backward direction Db may be different from the front-backward direction of the vehicle 1. The radial direction is a direction orthogonal to the central axis Ax. The circumferential direction is a direction around the central axis Ax.

The housing 21 is further provided with an output port 32 and an input port 33. Each of the output port 32 and the input port 33 communicates with the cylinder 31. In the axial direction, the output port 32 is away from the input port 33 in the forward direction Df.

The piston 22 is disposed inside the cylinder 31. The piston 22 can move axially inside the cylinder 31. The piston 22 defines part of the cylinder 31 as a liquid chamber 35. The liquid chamber 35 is provided between the piston 22 and the end portion 31a of the cylinder 31 in the forward direction Df in the axial direction.

The output port 32 communicates with the liquid chamber 35. The liquid chamber 35 is connected to the wheel cylinder 12 through the output port 32 and the liquid path 14. By moving the piston 22 in the forward direction Df, the volume of the liquid chamber 35 can be reduced, and the pressure in the brake fluid in the liquid chamber 35 and the wheel cylinder 12 can be increased. Further, by moving the piston 22 in the backward direction Db, the volume of the liquid chamber 35 can be expanded, and the pressure in the brake fluid in the liquid chamber 35 and the wheel cylinder 12 can be reduced.

In the radial direction, a gap is provided between the housing 21 and the piston 22. This gap allows the piston 22 to move axially relative to the housing 21. The two seals 23 and 24 seal the gap.

The seal 23 is away from the seal 24 in the forward direction Df. In the axial direction, the output port 32 communicates with the liquid chamber 35 at a position away from the seal 23 in the forward direction Df. In the axial direction, the input port 33 communicates with the cylinder 31 between the two seals 23 and 24. The seal 23 seals between the liquid chamber 35 and the input port 33.

The reservoir 25 is connected to the input port 33 through the liquid path 14. The reservoir 25 stores brake fluid and is opened to the atmosphere to be maintained at atmospheric pressure. When the piston 22 moves in the backward direction Db beyond the predetermined position, the input port 33 and the liquid chamber 35 communicate with each other. As a result, the brake fluid can freely flow between the liquid chamber 35 and the reservoir 25, and the pressure in the liquid chamber 35 decreases to the atmospheric pressure.

The rotation linear motion conversion mechanism 26 is disposed inside the cylinder 31. The rotation linear motion conversion mechanism 26 includes a rotating member 41, a linear motion member 42, and a plurality of balls 43. The rotation linear motion conversion mechanism 26 in the present embodiment is, for example, a ball screw. For this reason, the rotating member 41 may be referred to as a screw shaft. The linear motion member 42 may be referred to as a nut. Note that the rotation linear motion conversion mechanism 26 is not limited to this example.

The rotating member 41 is formed in a substantially columnar shape extending along the central axis Ax. The rotating member 41 has an outer peripheral face 41a and a male screw 41b. The outer peripheral face 41a is a substantially cylindrical curved face extending along the central axis Ax and faces outward in the radial direction. The male screw 41b is provided at the outer peripheral face 41a.

The linear motion member 42 includes a nut member 45 and a spacer 46. Note that the nut member 45 and the spacer 46 may be integrally formed. The nut member 45 is formed in a substantially cylindrical shape extending along the central axis Ax. The plurality of balls 43 is rollably held by the nut member 45 and is fitted to the male screw 41b of the rotating member 41. Therefore, the nut member 45 is attached to the rotating member 41 via the plurality of balls 43. The spacer 46 is interposed between the nut member 45 and the piston 22.

The motor 27 is disposed outside the housing 21. The motor 27 is, for example, a brushless motor. Note that the motor 27 may be another type of motor. The motor 27 includes an output shaft 51, and is controlled by, for example, the ECU 13 to rotate the output shaft 51.

The speed reduction mechanism 28 includes three gears 61, 62, and 63. The gear 61 is housed in the housing 21 at a position away from the piston 22 and the linear motion member 42 in the backward direction Db. The gear 61 is attached to the rotating member 41 so as to be rotatable integrally with the rotating member 41 about the central axis Ax. The gear 62 is attached to the output shaft 51 so as to be rotatable integrally with the output shaft 51. The gear 63 meshes with the gears 61 and 62.

The speed reduction mechanism 28 transmits the rotation of the output shaft 51 of the motor 27 to the rotating member 41. The motor 27 rotates the rotating member 41 in one direction (hereinafter, referred to as a forward rotation direction) around the central axis Ax or the other direction (hereinafter, referred to as a reverse rotation direction) around the central axis Ax via the speed reduction mechanism 28.

The rotating member 41 rotates in the forward rotation direction to push the nut member 45 in the forward direction Df via the ball 43. The nut member 45 pushes the piston 22 in the forward direction Df via the spacer 46. As a result, the linear motion member 42 and the piston 22 move (advance) in the forward direction Df. That is, the linear motion member 42 moves in the forward direction Df to push the piston 22 so as to reduce the volume of the liquid chamber 35.

On the other hand, the rotating member 41 rotates in the reverse rotation direction to push the nut member 45 in the backward direction Db via the ball 43. The C ring 29 is interposed between the piston 22 and the nut member 45 so that the nut member 45 can push the piston 22 in the backward direction Db. Therefore, the nut member 45 pushes the piston 22 in the backward direction Db via the C ring 29. As a result, the linear motion member 42 and the piston 22 move (retract) in the backward direction Db. That is, the linear motion member 42 moves in the forward direction Df or the backward direction Db in accordance with the rotation of the rotating member 41.

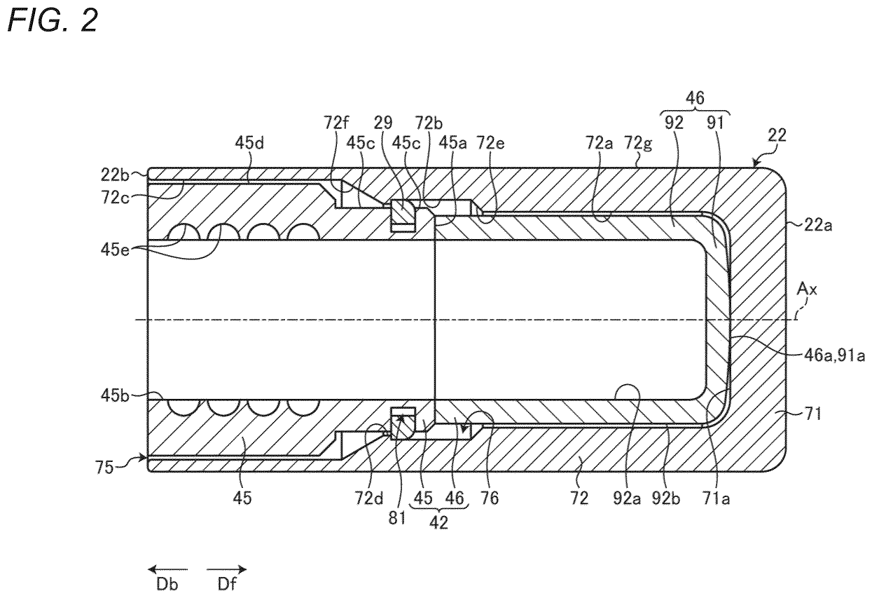

FIG. 2 is a cross-sectional view illustrating the piston 22, the C ring 29, and the linear motion member 42 of the present embodiment. Hereinafter, the piston 22, the C ring 29, and the linear motion member 42 will be described in detail.

The piston 22 has an end wall 71 and a peripheral wall 72. The end wall 71 is provided at the end portion 22a of the piston 22 in the forward direction Df. The end wall 71 is formed in a disk shape substantially orthogonal to the central axis Ax. The peripheral wall 72 is formed in a substantially cylindrical shape and extends in the backward direction Db along the central axis Ax from the edge of the end wall 71.

The end wall 71 has an inner face 71a. The inner face 71a faces in the substantially backward direction Db. The inner face 71a may be a flat face or a spherical face recessed in the forward direction Df. The peripheral wall 72 has three inner peripheral faces 72a, 72b, and 72c, a protrusion 72d, two inclined faces 72e and 72f, and an outer peripheral face 72g. The protrusion 72d is an example of a first engaging portion.

The inner peripheral faces 72a, 72b, and 72c are substantially cylindrical curved faces extending along the central axis Ax. The inner peripheral faces 72a, 72b, and 72c face in the central axis Ax. The three inner peripheral faces 72a, 72b, and 72c are disposed side by side in the axial direction.

The inner peripheral face 72a is connected to the inner face 71a of the end wall 71. The inner peripheral face 72c is connected to the end portion 22b of the piston 22 in the backward direction Db. The inner peripheral face 72b is located between the inner peripheral face 72a and the inner peripheral face 72c in the axial direction. The diameter of the inner peripheral face 72b is larger than the diameter of the inner peripheral face 72a and smaller than the diameter of the inner peripheral face 72c.

The protrusion 72d protrudes radially inward from the end portion of the inner peripheral face 72b in the backward direction Db. The protrusion 72d is formed in an annular shape extending around the central axis Ax. Note that the protrusion 72d is not limited to this example. The minimum diameter of the protrusion 72d is equal to or larger than the diameter of the inner peripheral face 72a.

The inclined face 72e is provided between the inner peripheral face 72a and the inner peripheral face 72b. The inclined face 72e is a substantially conical curved face that tapers from the inner peripheral face 72b toward the inner peripheral face 72a. Instead of the inclined face 72e, a face orthogonal to the central axis Ax may be provided between the inner peripheral face 72a and the inner peripheral face 72b.

The inclined face 72f is provided between the inner peripheral face 72c and the protrusion 72d. The inclined face 72f is a substantially conical curved face that tapers from the inner peripheral face 72c toward the protrusion 72d. Part of the inclined face 72f may be included in the protrusion 72d.

The outer peripheral face 72g is located opposite the inner peripheral faces 72a, 72b, and 72c and faces outward in the radial direction. The two seals 23 and 24 in FIG. 1 are in contact with the outer peripheral face 72g and seal a gap between the outer peripheral face 72g and the housing 21.

As shown in FIG. 2, the piston 22 has a recess 75. The recess 75 is formed (defined, partitioned) by the inner face 71a of the end wall 71, the inner peripheral faces 72a, 72b, and 72c of the peripheral wall 72, the protrusion 72d, and the inclined faces 72e and 72f. The recess 75 may be formed by another portion of the piston 22. The recess 75 opens at the end portion 22b of the piston 22 in the backward direction Db. That is, the recess 75 is open in the backward direction Db.

Further, the piston 22 has an engagement groove 76. The engagement groove 76 is located inside the recess 75. The engagement groove 76 is provided between the protrusion 72d and the inclined face 72e in the axial direction. The engagement groove 76 is recessed radially outward from the inner peripheral face 72a and the radially inner end portion of the protrusion 72d. The engagement groove 76 is formed in an annular shape extending around the central axis Ax.

The linear motion member 42 is disposed inside the recess 75 of the piston 22. For example, part of the linear motion member 42 may be located outside the recess 75. The nut member 45 of the linear motion member 42 has an end face 45a, an inner peripheral face 45b, and two outer peripheral faces 45c and 45d.

The end face 45a is provided at the end portion of the nut member 45 in the forward direction Df and faces in the forward direction Df. The inner peripheral face 45b is a substantially cylindrical curved face extending in the backward direction Db along the central axis Ax from the inner edge of the end face 45a. The outer peripheral faces 45c and 45d are substantially cylindrical curved faces extending along the central axis Ax. The outer peripheral face 45c extends in the backward direction Db from an outer edge of the end face 45a. The outer peripheral face 45d is away from the outer peripheral face 45c in the backward direction Db.

The diameter of the inner peripheral face 45b is slightly larger than the diameter of the outer peripheral face 41a of the rotating member 41. The diameter of the outer peripheral face 45c is smaller than the diameter of the outer peripheral face 45d. Furthermore, the diameter of the outer peripheral face 45c is the same as or larger than the diameter of the inner peripheral face 72a of the piston 22, and is shorter than the minimum diameter of the protrusion 72d. The diameter of the outer peripheral face 45d is larger than the minimum diameter of the protrusion 72d of the piston 22 and smaller than the diameter of the inner peripheral face 72c.

The outer peripheral face 45c faces the inner peripheral face 72b, the protrusion 72d, and the inclined face 72f of the piston 22. A gap is provided between the outer peripheral face 45c and the protrusion 72d. The outer peripheral face 45d faces the inner peripheral face 72c of the piston 22. A gap is provided between the outer peripheral face 45d and the inner peripheral face 72c. Therefore, the piston 22 and the nut member 45 are relatively movable in the radial direction.

The inner peripheral face 45b has a plurality of holding portions 45e. The plurality of holding portions 45e rollably holds the plurality of balls 43. The holding portion 45e may be, for example, a female screw or a substantially hemispherical recess.

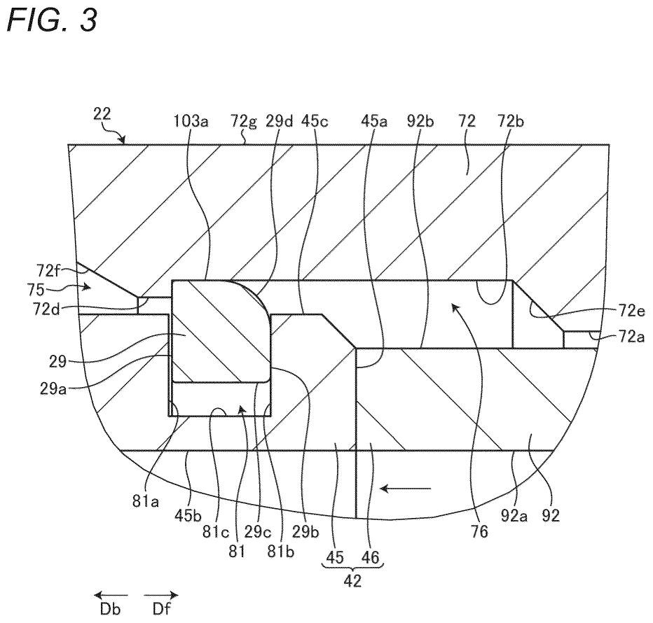

FIG. 3 is a cross-sectional view partially illustrating the piston 22, the C ring 29, and the linear motion member 42 of the present embodiment. As illustrated in FIG. 3, the nut member 45 has a groove 81. The groove 81 is recessed radially inward from the outer peripheral face 45c. Thus, the groove 81 is located inside the recess 75 of the piston 22. The groove 81 is an annular groove extending around the central axis Ax.

The nut member 45 further includes two side faces 81a and 81b and a bottom face 81c forming the groove 81. The two side faces 81a and 81b are annular planes disposed substantially in parallel. The side face 81a faces in the forward direction Df. The side face 81b is away from the side face 81a in the forward direction Df and faces in the backward direction Db. The two side faces 81a and 81b face each other. The bottom face 81c is a substantially cylindrical curved face extending along the central axis Ax between the radially inner edge of the side face 81a and the radially inner edge of the side face 81b.

As illustrated in FIG. 2, the spacer 46 has an end wall 91 and a peripheral wall 92. The end wall 91 is provided at the end portion 46a of the spacer 46 in the forward direction Df. The end wall 91 is formed in a disk shape substantially orthogonal to the central axis Ax. The peripheral wall 92 is formed in a substantially cylindrical shape and extends in the backward direction Db along the central axis Ax from the edge of the end wall 91.

The end wall 91 has an outer face 91a. The outer face 91a faces substantially in the forward direction Df. The outer face 91a is, for example, a spherical face bulging in the forward direction Df. The peripheral wall 92 has an inner peripheral face 92a and an outer peripheral face 92b. The inner peripheral face 92a is a substantially cylindrical curved face extending along the central axis Ax and faces the central axis Ax. The outer peripheral face 92b is located opposite the inner peripheral face 92a. The outer peripheral face 92b is a substantially cylindrical curved face extending from an edge of the outer face 91a in the backward direction Db along the central axis Ax.

The spacer 46 is interposed between the end face 45a of the nut member 45 and the inner face 71a of the piston 22. The outer face 91a faces the inner face 71a of the piston 22. The outer peripheral face 92b faces the inner peripheral faces 72a and 72b and the inclined face 72e of the piston 22.

The diameter of the inner peripheral face 92a is slightly larger than the diameter of the outer peripheral face 41a of the rotating member 41. The diameter of the outer peripheral face 92b is smaller than the diameter of the inner peripheral face 72a of the piston 22. A gap is provided between the outer peripheral face 92b and the inner peripheral face 72a. Therefore, the piston 22 and the spacer 46 are relatively movable in the radial direction.

As described above, the piston 22 and the linear motion member 42 are relatively movable in the radial direction. The piston 22 and the linear motion member 42 may be partially brought into contact with each other by relatively moving in the radial direction.

The spherical outer face 91a contacts the inner face 71a of the end wall 71 or is slightly away from the inner face 71a. Therefore, the piston 22 can swing with respect to the linear motion member 42 so that the central axis of the piston 22 is inclined with respect to the central axis (central axis Ax) of the linear motion member 42.

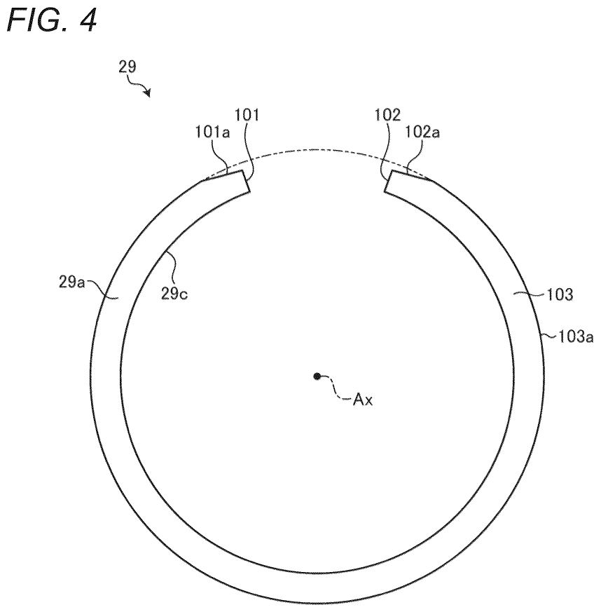

FIG. 4 is a plan view illustrating the C ring 29 of the present embodiment. The C ring 29 extends around the central axis Ax and is formed in a substantially annular shape partially missing. As illustrated in FIG. 4, the C ring 29 has two end portions 101 and 102 and an intermediate portion 103.

The end portions 101 and 102 are provided at both ends of the C ring 29 around the central axis Ax. The end portions 101 and 102 includes not only the end face of the C ring 29 around the central axis Ax but also a portion in the vicinity of the end face. The intermediate portion 103 is provided between both end portions 101 and 102 around the central axis Ax.

An outer edge 103a of the intermediate portion 103 extends in a substantially perfect circular shape around the central axis Ax. In other words, the diameter of the outer edge 103a is substantially constant. The outer edge 103a is an outer edge of the intermediate portion 103 in the radial direction.

The outer edges 101a and 102a of each of the end portions 101 and 102 are closer to the central axis Ax than the outer edge 103a of the intermediate portion 103. In other words, the diameter of each of the outer edges 101a and 102a is shorter than the diameter of the outer edge 103a. The outer diameter of the C ring 29 may be constant.

The both end portions 101 and 102 are away from each other in the circumferential direction. Therefore, the C ring 29 can be elastically deformed so as to reduce or increase the inner diameter and the outer diameter by bringing the both end portions 101 and 102 close to each other or away from each other.

As illustrated in FIG. 3, the C ring 29 further includes two side faces 29a and 29b, an inner edge 29c, and a curved face 29d. Each of the end portions 101 and 102 and the intermediate portion 103 has part of each of the side faces 29a and 29b, the inner edge 29c, and the curved face 29d.

The two side faces 29a and 29b are substantially annular planes disposed substantially in parallel. The side face 29a faces in the backward direction Db. The side face 29b is away from the side face 29a in the forward direction Df and faces in the forward direction Df. The distance between the side face 29a and the side face 29b is shorter than the distance between the side face 81a and the side face 81b of the groove 81.

The inner edge 29c is a substantially cylindrical curved face extending along the central axis Ax between the radially inner edge of the side face 29a and the radially inner edge of the side face 29b. The inner edge 29c is located opposite the outer edges 101a, 102a, and 103a. The inner edge 29c faces in the central axis Ax.

The curved face 29d is provided between the outer edges 101a, 102a, and 103a and the side face 29b. The curved face 29d is a corner portion between the outer edges 101a, 102a, and 103a that are so-called R-chamfered and the side face 29b, and is a substantially arc-shaped curved face. Note that the curved face 29d is not limited to this example.

The C ring 29 is attached to the nut member 45 by being fitted into the groove 81. In other words, the C ring 29 is provided at the nut member 45. The side face 29a of the C ring 29 faces the side face 81a of the nut member 45. The side face 29b of the C ring 29 faces the side face 81b of the nut member 45. The inner edge 29c of the C ring 29 faces the bottom face 81c of the nut member 45.

Part of the C ring 29 protrudes radially outward from the outer peripheral face 45c of the nut member 45. The part of the C ring 29 is fitted into the engagement groove 76 of the piston 22. In other words, the C ring 29 is positioned between the protrusion 72d and the inclined face 72e of the peripheral wall 72.

The side face 29a of the C ring 29 faces the protrusion 72d of the peripheral wall 72. The outer edges 101a, 102a, and 103a of the C ring 29 face the inner peripheral face 72b of the peripheral wall 72. The curved face 29d of the C ring 29 faces the inclined face 72e of the peripheral wall 72 at an interval.

The C ring 29 is fitted into the engagement groove 76 and the groove 81 in a state of being elastically deformed so that the outer diameter is reduced. The outer edge 103a of the intermediate portion 103 is in contact with the inner peripheral face 72b of the peripheral wall 72. The C ring 29 can suppress rattling by pushing the inner peripheral face 72b by a restoring force of elastic deformation. The outer edge 103a of the intermediate portion 103 may be away from the inner peripheral face 72b of the peripheral wall 72.

The inner edge 29c of the C ring 29 is away from the bottom face 81c of the nut member 45. The distance between the inner edge 29c of the C ring 29 and the bottom face 81c of the nut member 45 is longer than the length of the protrusion 72d in the radial direction. That is, for example, when the inner edge 29c comes into contact with the bottom face 81c due to the elastic deformation of the C ring 29, the diameter of the outer edge 103a of the intermediate portion 103 is smaller than the minimum diameter of the protrusion 72d.

As illustrated in FIG. 2, when the nut member 45 moves in the forward direction Df, the end face 45a of the nut member 45 pushes the spacer 46 in the forward direction Df. As a result, the outer face 91a of the spacer 46 comes into contact with the inner face 71a of the piston 22 and pushes the piston 22 in the forward direction Df.

As described above, the nut member 45 pushes the piston 22 in the forward direction Df via the spacer 46. As a result, the nut member 45, the spacer 46, and the piston 22 move integrally in the forward direction Df.

As illustrated in FIG. 3, when the nut member 45 moves in the backward direction Db, the side face 81b of the nut member 45 comes into contact with the side face 29b of the C ring 29, and pushes the C ring 29 in the backward direction Db. As a result, the side face 29a of the C ring 29 comes into contact with the protrusion 72d of the piston 22, and pushes the piston 22 in the backward direction Db. Further, the inner face 71a of the piston 22 contacts the outer face 91a of the spacer 46 and pushes the spacer 46 in the backward direction Db.

As described above, the nut member 45 pushes the piston 22 in the backward direction Db via the C ring 29. Further, the nut member 45 pushes the spacer 46 in the backward direction Db via the C ring 29 and the piston 22. As a result, the nut member 45, the spacer 46, and the piston 22 move integrally in the backward direction Db.

In other words, the C ring 29 contacts the protrusion 72d to restrict the separation of the linear motion member 42 from the piston 22 in the backward direction Db. When the C ring 29 is caught by the protrusion 72d, the linear motion member 42 moving in the backward direction Db drives the piston 22.

Since the outer edge 103a of the intermediate portion 103 comes into contact with the inner peripheral face 72b of the peripheral wall 72, the contact area between the side face 29a of the C ring 29 and the protrusion 72d of the piston 22 is kept substantially constant. For this reason, the C ring 29 can secure the load resistance of the engagement with the protrusion 72d and can suppress the disengagement from the engagement groove 76.

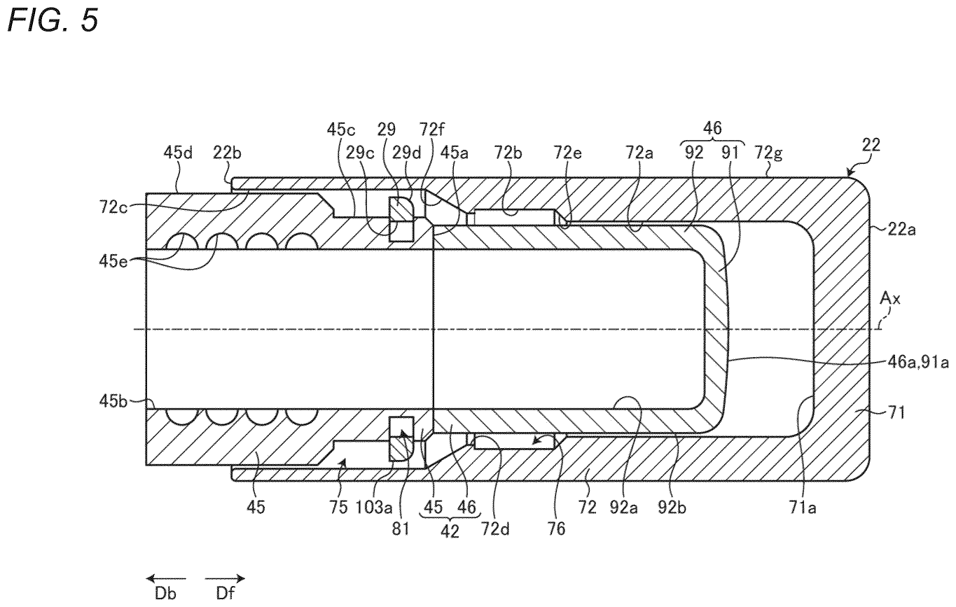

Hereinafter, part of the method of assembling the piston 22 and the linear motion member 42, which is part of the method of manufacturing the electric cylinder device 11, will be exemplified with reference to FIG. 5. The method of assembling the piston 22 and the linear motion member 42 is not limited to the following method, and other methods may be used.

FIG. 5 is a cross-sectional view illustrating the piston 22, the C ring 29, and the linear motion member 42 before the assembly of the present embodiment. As illustrated in FIG. 5, in the C ring 29 that is not elastically deformed, the diameter of the inner edge 29c of the C ring 29 is shorter than the diameter of the outer peripheral face 45c of the nut member 45. Furthermore, the diameter of the outer edge 103a of the intermediate portion 103 is larger than the diameter of the inner peripheral face 72b of the peripheral wall 72.

First, the C ring 29 is fitted into the groove 81 of the nut member 45. Next, the linear motion member 42 is inserted into the recess 75 of the piston 22 in a state where the spacer 46 is disposed between the inner face 71a of the piston 22 and the end face 45a of the nut member 45.

When the linear motion member 42 is inserted into the recess 75, the outer peripheral face 45d of the nut member 45 is guided by the inner peripheral face 72c of the peripheral wall 72. When the linear motion member 42 moves in the forward direction Df with respect to the piston 22, the curved face 29d of the C ring 29 contacts the inclined face 72f of the peripheral wall 72.

When the linear motion member 42 further moves in the forward direction Df with respect to the piston 22, the inclined face 72f pushes the curved face 29d toward the central axis Ax. As a result, the C ring 29 is elastically deformed so that the outer edge 103a of the intermediate portion 103 is reduced. Since the curved face 29d comes into contact with the inclined face 72f, it is possible to suppress the C ring 29 caught into the inclined face 72f.

As the linear motion member 42 further moves in the forward direction Df with respect to the piston 22, the diameter of the outer edge 103a of the intermediate portion 103 is smaller than the smallest diameter of the protrusion 72d. As the linear motion member 42 further moves, the C ring 29 passes over the protrusion 72d.

When the C ring 29 passes over the protrusion 72d, the diameter of the outer edge 103a of the intermediate portion 103 is increased by restoration from elastic deformation. As a result, as illustrated in FIG. 3, the outer edge 103a comes into contact with the inner peripheral face 72b of the peripheral wall 72.

As illustrated in FIG. 2, when the end face 45a of the nut member 45 is in contact with the spacer 46 and the outer face 91a of the spacer 46 is in contact with the inner face 71a of the piston 22, the side face 29a of the C ring 29 is away from the protrusion 72d. Therefore, the C ring 29 can reliably pass over the protrusion 72d.

As illustrated in FIG. 3, the curved face 29d of the C ring 29 is away from the inclined face 72e of the piston 22 in the backward direction Db. Therefore, for example, even when the end wall 91 of the spacer 46 is worn, it is possible to suppress the contact of the curved face 29d with the inclined face 72e.

In the present embodiment, the protrusion 72d is formed integrally with the piston 22. However, the protrusion 72d (first engaging portion) may be a component different from the piston 22. For example, the protrusion 72d may be a C ring fitted into a groove of the inner peripheral face 72b. In this case, instead of the C ring 29, the nut member 45 may have a protrusion (second engaging portion) protruding from the outer peripheral face 45c. That is, the second engaging portion may be formed integrally with the linear motion member 42.

The first engaging portion may be formed integrally with the piston 22, and the second engaging portion may be formed integrally with the nut member 45. In this case, when at least one of the first engaging portion and the second engaging portion is provided with, for example, a slit, it is elastically deformably formed in the radial direction.

In the brake system 10 according to the present embodiment described above, the linear motion member 42 is attached to the rotating member 41 so as to move in the forward direction Df or the backward direction Db along the central axis Ax according to the rotation of the rotating member 41. The linear motion member 42 moves in the forward direction Df to push the piston 22 so as to reduce the volume of the liquid chamber 35 of the cylinder 31. The piston 22 has the protrusion 72d. The C ring 29 is provided at the linear motion member 42, and contacts the protrusion 72d, and restricts the separation of the linear motion member 42 from the piston 22 in the backward direction Db. In other words, the C ring 29 restricts the separation of the piston 22 from the linear motion member 42 in the forward direction Df. Thereby, for example, when the pressure in the liquid chamber 35 decreases, the protrusion 72d and the C ring 29 can suppress the separation of the piston 22 pulled by the negative pressure from the linear motion member 42. Therefore, the responsiveness of the pressure increase in the liquid chamber 35 to the movement of the linear motion member 42 in the forward direction Df by the rotating member 41 is improved. Furthermore, noise generation due to collision between the piston 22 and the linear motion member 42 is suppressed. In addition, as compared with a case where the spring of the liquid chamber 35 presses the piston 22 against the linear motion member 42, the linear motion member 42 can move the piston 22 in the forward direction Df without receiving resistance by the spring. Therefore, the responsiveness of the pressure increase in the liquid chamber 35 to the movement of the linear motion member 42 in the forward direction Df by the rotating member 41 is improved.

The piston 22 has a recess 75 opened in the backward direction Db. The linear motion member 42 has a groove 81 located inside the recess 75 and extending around the central axis Ax. The C ring 29 as the second engaging portion is attached to the linear motion member 42 by being fitted into the groove 81. As a result, in the electric cylinder device 11, as compared with the case where the second engaging portion is formed integrally with the linear motion member 42, the second engaging portion can be simplified, and furthermore, the dimensional accuracy and durability of the second engaging portion can be easily improved, and the cost can be reduced.

The C ring 29 includes both end portions 101 and 102 around the central axis Ax and the intermediate portion 103 provided between the both end portions 101 and 102 around the central axis Ax. The outer edges 101a and 102a of the both end portions 101 and 102 are closer to the central axis Ax than the outer edge 103a of the intermediate portion 103. As a result, the C ring 29 can suppress damaging of the inner peripheral face 72c and the inclined face 72f of the piston 22 by both end portions 101 and 102.

The piston 22 and the linear motion member 42 are relatively movable in the radial direction. As a result, even when eccentricity between the piston 22 and the linear motion member 42 or relative inclination between the piston 22 and the linear motion member 42 occurs, an increase in the load acting on each other between the piston 22 and the linear motion member 42 is suppressed. Therefore, the electric cylinder device 11 can suppress the immovable state of the linear motion member 42 and the piston 22, and can suppress an increase in wear of the piston 22 and the linear motion member 42 due to the load.

The electric cylinder device 11 increases the pressure in the wheel cylinder 12 by reducing the volume of the liquid chamber 35. For example, the pressure in the liquid chamber 35 may be reduced by the wheel cylinder 12 or by various elements between the wheel cylinder 12 and the liquid chamber 35. As described above, the electric cylinder device 11 can suppress the separation of the piston 22 from the linear motion member 42 when the pressure in the liquid chamber 35 decreases. Therefore, the responsiveness of the pressure increase in the liquid chamber 35 to the movement of the linear motion member 42 in the forward direction Df by the rotating member 41 is improved. Furthermore, noise generation due to collision between the piston 22 and the linear motion member 42 is suppressed.

As an example, an electric cylinder device according to at least one embodiment described above includes a housing provided with a cylinder, a piston disposed inside the cylinder, a rotating member that rotates about a rotational axis, a linear motion member attached to the rotating member so as to move in a first direction along the rotational axis or a second direction opposite to the first direction according to rotation of the rotating member, the linear motion member pushing the piston so as to reduce a volume of a liquid chamber of the cylinder by moving in the first direction, and a first engaging portion provided at the piston, a second engaging portion that is provided at the linear motion member and contacts the first engaging portion to restrict a separation of the linear motion member from the piston in the second direction. Therefore, as an example, the first engaging portion and the second engaging portion can suppress the separation of the piston pulled by the negative pressure from the linear motion member, for example, when the pressure in the liquid chamber decreases. Therefore, the responsiveness of the pressure increase in the liquid chamber to the rotating member moving the linear motion member in the first direction is improved. Furthermore, noise generation due to collision between the piston and the linear motion member is suppressed. In addition, as compared with a case where the spring presses the piston against the linear motion member, the linear motion member can move the piston in the first direction without receiving resistance by the spring. Therefore, the responsiveness of the pressure increase in the liquid chamber to the rotating member moving the linear motion member in the first direction is improved.

As an example, in the electric cylinder device described above, the piston has a recess opened in the second direction, wherein the linear motion member has a groove located inside the recess and extending around the rotational axis, and wherein the second engaging portion includes a C ring attached to the linear motion member by being fitted into the groove. Therefore, as an example, in the electric cylinder device, as compared with the case where the second engaging portion is integrally formed with the linear motion member, the second engaging portion can be simplified, and furthermore, the dimensional accuracy and durability of the second engaging portion can be easily improved, and the cost can be reduced.

As an example, in the electric cylinder device described above, the C ring has both end portions around the rotational axis and an intermediate portion provided between the both end portions around the rotational axis, and wherein an outer edge of each of the both end portions in a radial direction orthogonal to the rotational axis is closer to the rotational axis than an outer edge of the intermediate portion in the radial direction. Therefore, as an example, the C ring can suppress damaging of the inner face of the piston by both end portions.

As an example, in the electric cylinder device described above, the piston and the linear motion member are relatively movable in a direction orthogonal to the rotational axis. Therefore, as an example, even when eccentricity between the piston and the linear motion member or relative inclination between the piston and the linear motion member occurs, an increase in the load acting on each other between the piston and the linear motion member is suppressed. Therefore, the electric cylinder device can suppress the immovable state of the linear motion member and the piston, and can suppress an increase in wear of the piston and the linear motion member due to the load.

As an example, a brake fluid pressure control device according to at least one embodiment described above includes, a wheel cylinder, and the electric cylinder device described above, the electric cylinder device being capable of increasing a pressure in the wheel cylinder by reducing a volume of the liquid chamber. Thus, as an example, the pressure in the liquid chamber may be reduced, for example, by the wheel cylinder or by various elements between the wheel cylinder and the liquid chamber. As described above, the electric cylinder device can suppress the separation of the piston from the linear motion member when the pressure in the liquid chamber decreases. Therefore, the responsiveness of the pressure increase in the liquid chamber to the rotating member moving the linear motion member in the first direction is improved. Furthermore, noise generation due to collision between the piston and the linear motion member is suppressed.

In the above description, “suppress” is defined as, for example, preventing the occurrence of an event, an action, or an influence, or reducing the degree of the event, the action, or the influence. Furthermore, in the above description, “restrict” is defined as, for example, preventing movement or rotation, or allowing movement or rotation within a predetermined range and preventing movement or rotation beyond the predetermined range.

Although the embodiments of the present disclosure have been exemplified above, the above-described embodiments and modifications are merely examples, and are not intended to limit the scope of the disclosure. The above-described embodiments and modifications can be implemented in various other forms, and various omissions, substitutions, combinations, and changes can be made without departing from the gist of the disclosure. In addition, the configuration and shape of each embodiment and each modification can be partially interchanged.

1. An electric cylinder device comprising:
a housing provided with a cylinder;
a piston disposed inside the cylinder;
a rotating member that rotates about a rotational axis;
a linear motion member attached to the rotating member so as to move in a first direction along the rotational axis or a second direction opposite to the first direction according to rotation of the rotating member, the linear motion member pushing the piston so as to reduce a volume of a liquid chamber of the cylinder by moving in the first direction;
a first engaging portion provided at the piston; and
a second engaging portion that is provided at the linear motion member and contacts the first engaging portion to restrict a separation of the linear motion member from the piston in the second direction.

2. The electric cylinder device according to claim 1, wherein
the piston has a recess opened in the second direction, wherein
the linear motion member has a groove located inside the recess and extending around the rotational axis, and wherein
the second engaging portion includes a C ring attached to the linear motion member by being fitted into the groove.

3. The electric cylinder device according to claim 2, wherein
the C ring has both end portions around the rotational axis and an intermediate portion provided between the both end portions around the rotational axis, and wherein
an outer edge of each of the both end portions in a radial direction orthogonal to the rotational axis is closer to the rotational axis than an outer edge of the intermediate portion in the radial direction.

4. The electric cylinder device according to claim 1, wherein
the piston and the linear motion member are relatively movable in a direction orthogonal to the rotational axis.

5. A brake fluid pressure control device comprising:
a wheel cylinder; and
the electric cylinder device according claim 4, the electric cylinder device being capable of increasing a pressure in the wheel cylinder by reducing a volume of the liquid chamber.

6. A brake fluid pressure control device comprising:
a wheel cylinder; and
the electric cylinder device according to claim 3, the electric cylinder device being capable of increasing a pressure in the wheel cylinder by reducing a volume of the liquid chamber.

7. A brake fluid pressure control device comprising:
a wheel cylinder; and
the electric cylinder device according to claim 2, the electric cylinder device being capable of increasing a pressure in the wheel cylinder by reducing a volume of the liquid chamber.

8. A brake fluid pressure control device comprising:
a wheel cylinder; and
the electric cylinder device according to claim 1, the electric cylinder device being capable of increasing a pressure in the wheel cylinder by reducing a volume of the liquid chamber.
